(19) United States
(12) Patent Application Publication
(10) Pub. No.: US 2005/0154500 A1
(43) Pub. Date: Jul. 14, 2005

(54) Method and device for emitting and/or receiving information relating to a vehicle

(76) Inventors: Thomas Sonnenrein, Bockenem (DE); Norbert Bauer, Bad Neustadt (DE)

Correspondence Address: KENYON & KENYON, ONE BROADWAY, NEW YORK, NY, 10004, US

(21) Appl. No.: 10/514,023

(22) PCT Filed: May 20, 2003
(86) PCT No.: PCT/DE03/01625

(30) Foreign Application Priority Data
Jun. 10, 2002 (DE) 102 25 786.8

(51) Int. Cl. G06F 7/00

(52) U.S. Cl. 701/1; 701/2

(57) ABSTRACT

A method and device for transmitting, sending and/or receiving information in conjunction with a vehicle. Information used for implementing vehicle-related remote monitoring being transmitted via a mobile radio network. In this connection, the communication takes place on the basis of a standardized protocol that is adapted to the conditions of the mobile radio network, which may be the WAP protocol.

### FIELD OF THE INVENTION

The present invention relates to a method and device for transmitting, sending and/or receiving information in conjunction with a vehicle, in particular, for remote diagnostics, remote control and/or remote operation of a component/function of the vehicle.

### BACKGROUND INFORMATION

A method and device for transmitting, sending and/or receiving information in conjunction with a vehicle is discussed in German patent document no. 100 26 754. In order to implement remote maintenance, remote diagnostics and/or remote control of a motor vehicle, of one of its components and/or functions, data is exchanged via a telecommunications network and/or a data network. A mobile radio network according to GSM or UMTS standard is proposed as an example for the telecommunications network while the Internet is mentioned as an example for the data network. No reference is made to the specific embodiment, in particular, with respect to the flexibility and/or reliability and/or security of the information exchange, and/or with respect to the reduction in complexity, in particular, of the terminal devices in the vehicle.

### SUMMARY OF THE INVENTION

Communication of mobile terminal devices with stationary computers in the Internet via standardized communications paths, for example, via the WAP protocol, allows telematics terminals that are provided with a suitable access and are already present in the vehicle to be used for performing vehicle-related telematics applications, such as remote query and/or remote control of vehicle components and/or for performing remote diagnostics, without requiring a complete redesign of these terminal devices and the corresponding expenditure.

It may be particularly advantageous to use the WAP protocol because its efficient transmission and/or security mechanisms are suitable for the specific use in mobile applications, in particular, for the above-mentioned vehicle-related telematics applications such as remote diagnosis of vehicle control units.

A further positive effect of using this protocol is that resources such as memory and computing power are reduced in the terminal devices because this protocol is specifically designed for terminal devices with few resources. When using this protocol, no additional functional units are needed for data transmission and content visualization. This is accomplished only by using a WAP browser, which is available, and the associated WAP communication stack. In terms of reducing resources in the terminal device, the use of the WAP protocol is especially beneficial if the WAP protocol is present in the terminal device anyway for other services such as mobile Internet. Thus, the synergy achieved by using this protocol is considerable.

By implementing the transmitted WAP contents in the form of WML pages, statically and dynamically generated contents, for example, for interaction with the user, may be provided by the server to the WAP browser in the terminal device. In this connection, the WML pages may also contain so-called “WML scripts” which allow for describing complex procedures in the terminal device. Because of this, parts of the terminal applications, such as remote diagnostics, do not have to be explicitly implemented therein themselves, but are already implemented in the WAP stack and universally usable.

It is a particular advantage that the WAP standard provides an interface (EFI interface) which allows the WAP browser (and thus indirectly the server) to communicate with independent external applications on the mobile terminal device via a standardized functional interface. Thus, mechanisms are provided that facilitate communication with software components which are not included in the browser, such as the diagnostics interface to the control units to be diagnosed.

A particular advantage is that, in addition to the above-mentioned vehicle-related telematics applications, such as remote diagnosis of vehicle control units, it is also possible to implement further telematics services via the standardized protocol, such as breakdown call, emergency call, or traffic information.

It may be especially beneficial that, using the standardized protocol, the communication between the terminal device and the server is implemented within the framework of fixedly predetermined sub-steps as a request/response communication based on standard data frames and contents (WML, WML script).

Using the existing security mechanisms, a particularly secure and reliable way of exchanging information may be provided in an especially advantageous manner after activating the telematics service through user identification, authentication and/or vehicle identification.

The use of a protocol standard that is adapted to mobile applications (such as WAP) shows particularly beneficial results in conjunction with telematics services in motor vehicles over mobile radio networks.

### BRIEF DESCRIPTION OF THE DRAWINGS

FIG. 1 shows a general view of a system for a vehicle-related telematics service.

FIG. 2 shows an exemplary embodiment of such a system based on the WAP protocol.

FIG. 3 shows a suitable exemplary embodiment of transmission steps via the interface between the telematics terminal device and the server.

FIG. 4 is a flow chart outlining the program flows in the telematics terminal device and in the server with the example of the communication shown in FIG. 3.

FIG. 5 is a flow chart outlining the program flows in the telematics terminal device and in the server with the example of the communication shown in FIG. 3.

### DETAILED DESCRIPTION

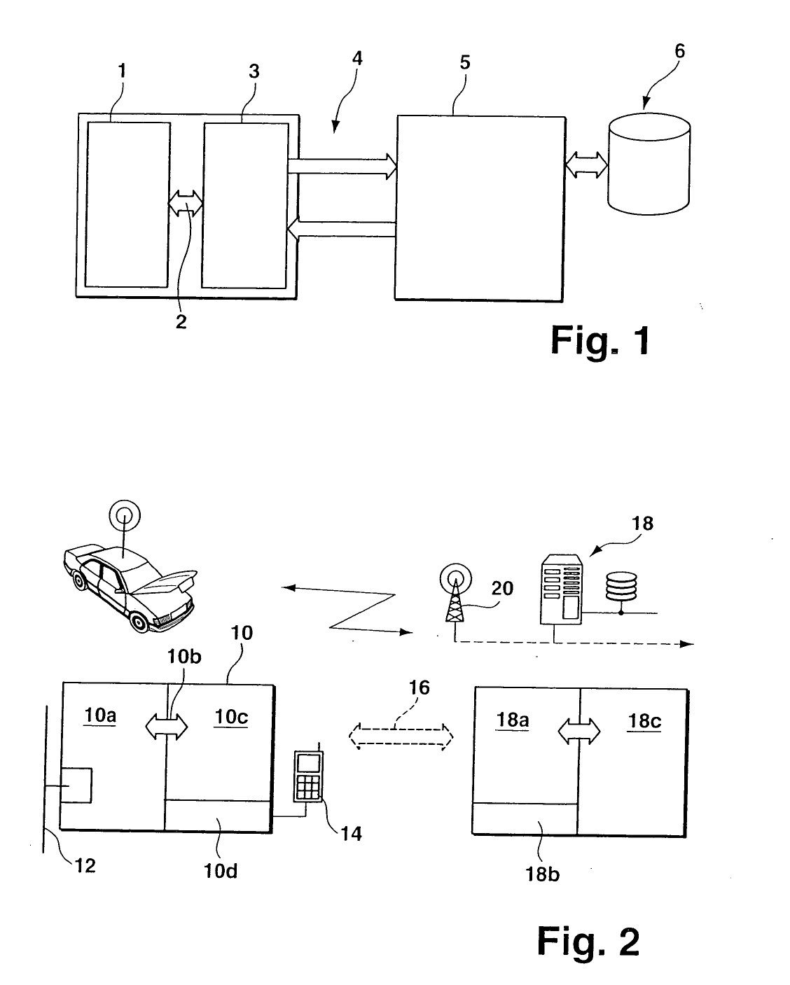

FIG. 1 shows a general view of a system for a vehicle-related telematics service whereby information is exchanged between a vehicle (there the terminal device) and a server over a mobile radio network or a data network, such as the Internet. A configuration of this kind is used in conjunction with functions for telecontrol, remote diagnostics, remote maintenance, software download, etc. In this context, “telecontrol” or “remote query” are basically understood to be the remote control of vehicle functions, in particular, convenience features such as switching on the parking heater, etc., as well as querying of vehicle statuses and/or operating parameters. In this connection, the user initiates a communication with the vehicle via a central server, or communicates directly with the vehicle. Remote diagnostics includes remote reading of diagnostic data from the vehicle, analysis thereof and, possibly, the generation of a recommendation for further action.

In this context, the analysis of the data and the generation of the recommendation are carried out by a central server that is in communication with the motor vehicle via a mobile radio network, a wired network and/or via a data network such as the Internet. The functions to be mentioned in this connection further include the so-called “software download” or remote flashing, which are used to load a new program code or parameter into software-configurable systems in the vehicle, such as control units, in order to enhance the functionalities or performance. Here too, communication is via a mobile radio network, a wired network and/or, for example, the Internet, originating from a central computer (server) or service center.

“Remote maintenance” is essentially the monitoring of the vehicle's condition and access to maintenance data in the vehicle from a central point to check if, when and which measures are carried out to maintain the desired condition. An example of this is the dynamic adaptation of maintenance intervals. These functionalities are generically subsumed here under the term “vehicle-related remote monitoring” (control).

All mentioned functions or services are implemented via the hereinafter described interface between the motor vehicle (there the terminal device) and a central computer, in particular, a server at a service center, or at the vehicle manufacturer or component supplier. If necessary, the control of the components and/or functions in the vehicle is carried out via an interface between the terminal device and the respective vehicle component, which will also be described hereinafter. In the following, the embodiment will be described with reference to the “remote diagnostics” service.

The interface is used correspondingly also in conjunction with many other services such as those mentioned above.

FIG. 1 shows a general view of a remote diagnostics system. On the vehicle side, the vehicle electronics system 1 is shown, for example, a network of control units, which is connected via a predefined interface 2 to on-board portion 3 of the remote diagnostics system, in particular, to a telematics terminal device. This on-board application uses the diagnostic mechanisms (on-board diagnostics) integrated in the vehicle electronics system, for example, to retrieve fault memory contents. The on-board portion of remote diagnostics system 3 accesses the vehicle network, and thus vehicle electronics system 1, i.e., the control units to be diagnosed, via interface 2, for example, a CAN bus or a K line, using a predefined communication protocol.

The described on-board portion is connected to central portion 5 of the remote diagnostics system via a further interface 4. This central portion may be the server or the computer system of a service center. In the exemplary embodiment, this server processes as many as possible of the tasks occurring during remote diagnosis so that as few resources as possible have to be kept available in the vehicle terminal device. For example, the server assumes the configuration of the diagnostic unit in the vehicle at the beginning of the diagnosis, the control of this unit during the process, as well as the evaluation of the acquired data. To this end, the server accesses vehicle-specific data and commands that are stored in data memory 6. The server of the exemplary embodiment is an Internet server.

In the exemplary embodiment, the link 4 between the server and the client (vehicle terminal device) is a mobile radio interface because of its properties in terms of coverage, availability and cost. The protocol used in conjunction with remote diagnostics for exchanging information is a standardized protocol which is adapted to the specific requirements of a mobile radio network. In connection with the above-described application, the Wireless Application Protocol (WAP) has turned out to be suitable. The WAP is a worldwide standardized protocol for communication of mobile terminal devices with stationary computers in the Internet, and includes various individual protocols that describe the entire communication process.

In this connection, each WAP-capable terminal device has a special WAP browser for interpreting and visualizing the standardized transmission contents. The transmitted contents are implemented in the form of WML pages. These pages may also contain so-called “WML scripts” which make it possible to describe complex procedures in the terminal device. There is also a standardized functional interface (EFI interface) which is part of the WAP browser and used for communication with software components that are not included in the browser, i.e., in particular, vehicle functions, diagnostic functions, etc.

Besides the described core capabilities of the WAP protocol, the specific application for remote diagnosis of motor vehicles or vehicle components makes use of the security mechanisms of the protocol. This eliminates the need for additional functional units in the terminal device for ensuring data transfer security and/or for providing access rights.

FIG. 2 is a diagram showing an implementation of a remote diagnostics system with WAP communication. On-board portion 10 (terminal device) is essentially made up of a module 10a including the functionalities of the diagnostics application, a module 10c, the WAP browser, and a communication module 10d which sends and receives information to and from the mobile radio network. Module 10a is connected to other control units and/or components of the vehicle via a bus system 12 (diagnostic bus), for example, a CAN bus. Information, data and/or commands are exchanged via these interfaces. Module 10a is linked to WEB browser 10c via a further interface 10b (EFI interface). Communication module 10d sends or receives data to or over air interface 16 via a transmitter/receiver 14, for example, a mobile radio device. Also provided (but not shown in FIG. 2) are an operating system for organizing the processes and, in module 10c, the so-called “WAP stack” which includes the functionalities for implementing the WAP protocol.

In one exemplary embodiment, the on-board portion of the system is integrated into a telematics terminal device, which also includes the described GSM module for mobile radio communication and the WAP stack for the Internet functionality. The connection to the diagnostic bus, usually via CAN, is also present. In place of or in addition to the GSM standard, mobile radio standards such as GPRS or UMTS are also well-suited for communication via WAP, because the GPRS and UMTS standards feature fast connection set-up, low delay times, and a high data transfer rate at low cost.

Communication between the vehicle terminal device and the central computing unit is via a mobile radio network 16. Central computing unit 18, in particular, a web server, receives or sends data from or to the on-board portion of the system via a transmitter/receiver device 20 of the mobile radio interface either directly or via a gateway computer. If a gateway computer is used on the network side, this gateway computer forms the WAP gateway (where the WAP stack is implemented). Usually, the dialing of mobile radio device 14 into the Internet takes place in such a gateway. In addition to the WAP module, the gateway computer includes, in particular, also the communication interface to the mobile radio network and the interface to the web server.

The tasks of the WAP gateway are, on the one hand, to convert the protocol from WAP to the HTTP Internet format, and vice versa, and, on the other hand, to compress and precompile the WML pages and scripts received from the queried web server before they are sent back to the mobile radio subscriber. As shown in FIG. 2, this gateway function is assumed by server 18 itself (module 18a, mobile radio network interface module 18b), while in another embodiment, the described tasks are assumed by a gateway computer connected to the server via an Internet connection.

The web server 18 of, for example, a service center, has the function of the diagnostics server. The software (module 18c) implemented in web server 18 responds to the requests of the client (terminal device) with dynamically generated response pages and response scripts. The dynamic generation of the responses is carried out using predefined scripts (programs) on the server side and a database 22 which contains all data required for the identification, configuration and execution of the diagnostics application in the vehicle for the particular requester.

The tasks of the web server include, on the one hand, general web server tasks such as processing of requests, distribution of the pages or files to the correct recipient, communication management, etc., and, moreover, primary sequence control of the diagnosis and configuration of the diagnostics application in the client via dynamically generated WML pages and WML scripts, provision and management of the data required for vehicle diagnostics in a database, management of the database itself, evaluation of the user data coming from the vehicle, provision or dynamic generation of the user interface for the remote diagnostics application in the vehicle. In this connection, the acquisition of the user data (fault memories), i.e., the diagnosis itself, takes place according to known diagnostic methods that are implemented in the vehicle.

During the diagnostic process, WML pages and WML scripts for controlling the diagnostic procedures are transmitted from the server to the terminal device and processed by the latter. In this connection, among other things, data therefrom is transferred to the CAN bus. A self-implemented man-machine interface in the on-board portion of the system is omitted because it is implemented by displaying the WML pages in the WAP browser.

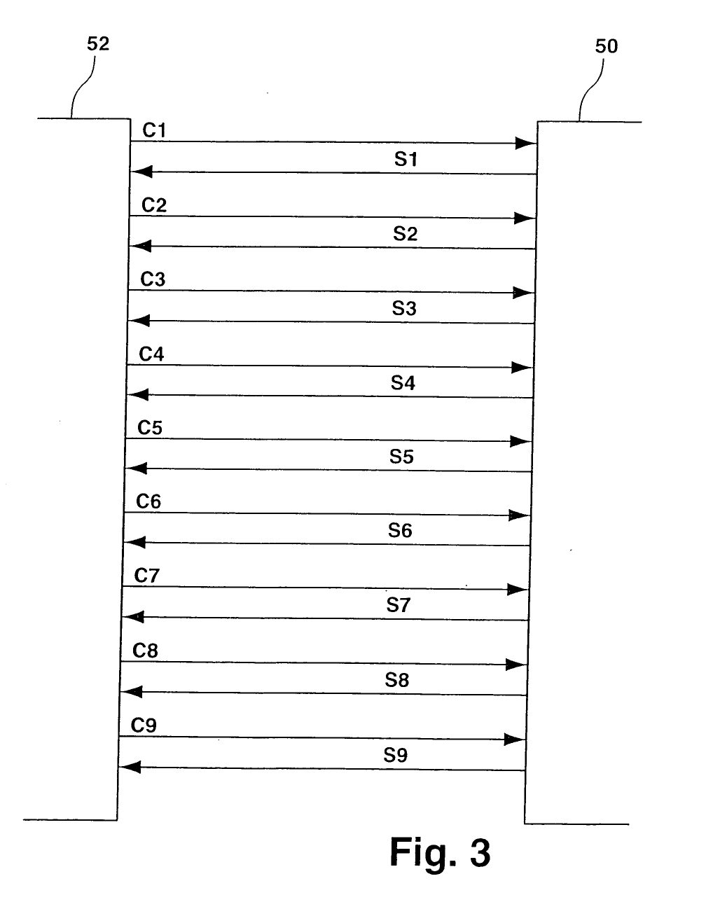

An example of the communication between server 50 and on-board portion 52 is illustrated with reference to FIG. 3. In the case shown, the communication process is initiated an operator, for example, the driver of the motor vehicle. In other embodiments, the remote diagnostic communication is activated by the service center. In one embodiment, initiation is performed by the server in an additional step prior to the representation of FIG. 3 by requesting the client, for example, by an SMS to the client, to establish a communication connection. In the WAP standard, such an operation is specified or standardized as a so-called “push”.

The contents or data that are relevant for remote diagnostics and which, in addition to the actual diagnostic data, also contain commands for the control and configuration of the remote diagnostics functionality integrated in the vehicle, are structured differently, depending on the variant. In a first embodiment, the remote diagnostics unit in the vehicle contains mechanisms and functions for performing the diagnostic procedures independently. Error memories of the control units are read out for data acquisition via remotely controlled functions in the telematics terminal device. The telematics terminal device contains functional units such as the transport protocol layer for CAN bus data, the protocol layer required for the logical diagnostic process, as well as a suitable sequence control.

In this connection, the required data for the respective protocol layers and for the sequence control may be downloaded from the diagnostics server at the beginning of the diagnostic process, and that the layers be configured using protocol macros and communications parameters. As a consequence, it may be necessary to also transmit parameters and diagnostic macros in addition to the actual control commands for remotely controlling the remote diagnostic functions. Moreover, the data required for parametrization is always permanently kept available in the telematics terminal device, which eliminates the need to transmit this data from the server to the client. A second embodiment proposes to transmit commands at the level of the diagnostic protocol. In this case, the unit in the vehicle does not perform the diagnostic process independently, but only passes the data coming from the server through to the control unit to be diagnosed. Thus, diagnostic protocol functionalities in the vehicle are reduced very significantly and to a minimum, and remain almost entirely in the server. In this case, the individual diagnostic commands are transmitted transparently over the air interface. Only a few simply structured messages are generated in the vehicle.

This means for the data contents transmitted during the diagnostic process that, in addition to the actual diagnostic data (fault memory contents), diagnostic commands that are specified, for example, according to the KWP 2000 diagnostic protocol standard, are transmitted as well. A third embodiment uses mixed forms of the two described, extreme variants of partitioning diagnostic functions between the telematics terminal device and the service center. For example, commands for remote control of the overall functions and individual commands of the diagnostic protocol that are not permanently integrated in the terminal device are transmitted in parallel.

In the representation of FIG. 3, on-board portion 52 of the diagnostic system is shown on the left, while network portion 50 is shown on the right. The arrows represent the flow of information, the chronological order of the requests and responses during the communication being shown from top to bottom. In this connection, the communication steps shown are examples. The number thereof may also be reduced, for example, by combining individual sub-sequences into one communication operation.

Initially, in step C1, the client requests a remote diagnostics start page from the service center. In the exemplary embodiment, this message is sent as a URL address which is stored in the terminal device. The request is initiated by an operator activating the remote diagnosis accordingly, for example, via a switch mounted in the vehicle, via an entry, a combination of commands, or in response to a prompt transmitted (by an operator, by the service center, etc.) via mobile radio. The server response is represented in step S1. In the exemplary embodiment, the server sends the terminal device a WAP page for activating the remote diagnosis in the vehicle. This page is implemented as a WML page. The two steps mentioned represent the sub-process of requesting the remote diagnostics service.

In the next step C2 after receipt of the WAP page, the client requests, either automatically or by user initiation, the transmission of a login page whose URL was included in the previously received page. Then, in step S2, the server provides the requested login page with a reference to a login script. Here too, the page is sent as a WML page containing a corresponding script reference. In the client, information about the loaded login page is optionally output to the user on a display. In the next step C3, the client automatically requests a login script for authentication and/or user identification to the server (service provider). The URL for that is determined via the script reference in the WML page. In subsequent step S3, the server sends the requested login script as a WML script for reading out the user data in the vehicle.

The client executes the script automatically or in response to operator input. Then, in step C4, sends the data (user identification data) to the server along with the request for the next WAP page. The server then checks the received user data and, if this data is determined to be correct, the remote diagnostics process is continued or, if not, it is aborted or step S3 is repeated. Steps S2 through C4 represent the user identification and authentication sequence.

Thus, if the user data is correct, the server starts the remote diagnosis in step 4 by sending a WAP page (as a WML page containing a script reference) which, inter alia, a login acknowledgement after successful identification of the user. This WAP page contains a reference to the WML script for motor vehicle identification. In the client, the received login acknowledgement is optionally displayed as user information on a display. In next step C5, the client sends a request to the server for a script for reading out the motor vehicle identification data. The URL address required for this is included in the script reference of step S4. The server accepts this request and, during step S5, it sends the client a script in the form of a WML script for reading out the motor vehicle identification data. After that, the corresponding identification data is read out in the client and sent to the server in step C6 along with the request for the next WAP page with data.

The server checks the received motor vehicle identification data (vehicle type, software version, if indicated, etc.), possibly along with GPS position data. Depending on the data, the diagnostic procedures and the required parameters are selected from the server's data base. With that, the sub-step of vehicle identification (S4 through C6) is completed, and the next WML page is requested from the server. The URL for that was also sent to the client in the sub-step that has just been completed.

Then, in step S6, the server sends the client a diagnostics continuation page containing, inter alia, status information together with a reference to a diagnostic script. This page is implemented as a WML page containing a script reference. In the client, the start of the diagnosis is optionally shown to the user on a display. Upon receipt of the information in step S6, the client sends the server a request to transmit the diagnostic script for reading out the diagnostic data. The URL address is taken from the script reference in step S6. In the server, the diagnostic script (WML script) is then generated based on this request, and sent to the client in step S7. By executing the diagnostic script, the on-board fault memories are then read out and sent to the server in step C8 with the request for the next WML page.

Steps S6 through C8 represent the sequence of reading out the diagnostic data, which may, in principle, be also carried out in several passes, i.e., using several sub-scripts. For example, one script for each control unit may be provided. The sub-process in this section is then carried out repeatedly.

A WAP continuation page containing the diagnostic result is requested via a URL address received in the preceding step. In the server, the diagnostic data (fault codes) is evaluated using a database, assessed (if applicable), and a diagnostics result page is dynamically generated. Then, in step S8, the result page is sent to the client as a WML page. In response to receiving the result page, the client outputs the diagnostic result on a display. Thus, step S8 represents the sequence of determining and outputting the diagnostic result.

In subsequent step C9, the client sends the server a further request (possibly by manual initiation) for a WAP page including a follow-up recommendation. The URL for that may either be store in the terminal device, or be transmitted together with the diagnostics result page. In the server receiving this request, a follow-up recommendation is generated as a function of the detected fault or faults, a recommendation page is built, and the diagnostic process is terminated. In step S9, the server sends the client the recommendation page as a WML page. The client outputs the established follow-up recommendation on a display.

It should be added that the WML scripts or pages (depending on the implementation) contain, at the end, the command for the browser to find the next WML page, and to load the data associated therewith, and, possibly, to send data acquired in the client to the server along with the request.

In the presented transmission scenario, the client repeatedly accesses the EFI interface specified in the WAP standard while executing the WML scripts mentioned above. The scenario described above is one embodiment, which may vary considerably depending on the individual case. However, the procedure for remote diagnostics always includes the following sub-steps, which are described above as a sub-process:
1. requesting the remote diagnostics service
2. identifying and authenticating the user
3. identifying the motor vehicle
4. reading out the diagnostic data
5. determining the diagnostic results
6. establishing a follow-up recommendation

In this connection, these sub-steps may be partially changed in order; sub-step 6 may possibly be omitted.

The number or length of the individual communication steps depends on the number of units to be diagnosed in the vehicle. The described sequence takes place at the time the remote diagnosis is activated until the diagnostic result is output in a completely automatic manner without further interaction with the user.

In the client, the scripts are executed by transmitting predefined commands via the CAN link to the control unit to be diagnosed. The data acquired by the control unit is transferred via the CAN link to the client, and sent by the client over the air interface to the server.

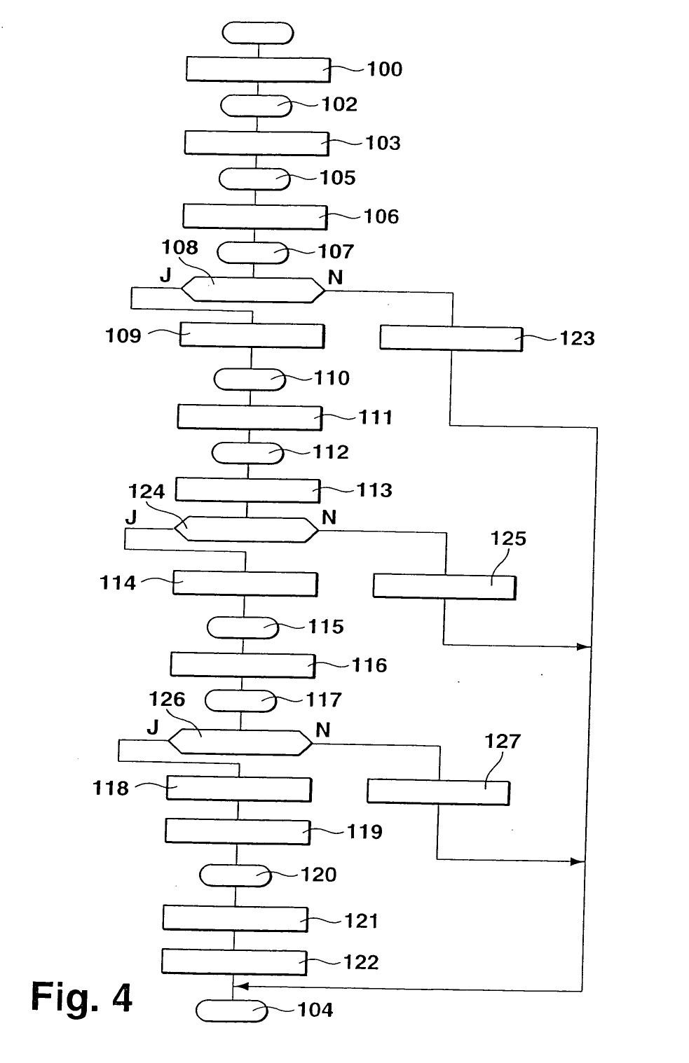

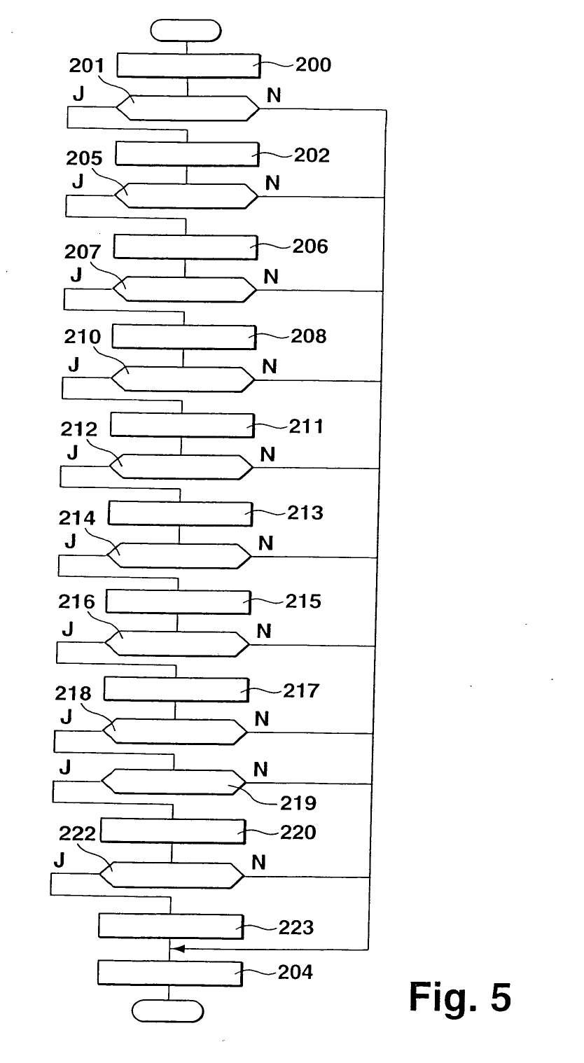

The procedure described above is implemented by suitable programs in the server and in the microcomputer of the terminal device, which are independent parts of the described invention. Examples of such programs are outlined in FIG. 4 (for the server) and FIG. 5 (for the terminal device).

The program according to FIG. 4 is started by a request for initiating the remote diagnosis. In step 100, the server sends a predefined WAP page for activation. The server always only responds to incoming requests; i.e., the server is in a kind of “inactive state” as long as no request is received. For the server, the communication is terminated when there is no further request coming from the client. In step 102, a request (URL address) for a login page is expected to be received. The receipt of a request is followed by step 103. If no request is received, then the communication is unsuccessfully terminated from the point of view of the server. In step 103, the server responds according to the request with a login page together with a script reference.

Then, in step 105, a request (URL address) for a login script is expected to be received. The receipt of a request is followed by step 106. If no request is received, then the communication is unsuccessfully terminated from the point of view of the server. In step 106, the server sends a login script according to the request. Then, in step 107, a request (URL address) for a next page as well as user identification and authentication data are expected to be received. The correct receipt of a request and data is followed by step 108. If no request and/or data is received, then the communication is unsuccessfully terminated. In step 108, the user identification and authentication data is checked. If this data matches prestored data, i.e., if the sender is authenticated, then step 109 follows. Otherwise a WML error message page is generated and sent to the client as a response to its incorrect request (step 123).

With that, the communication is terminated (step 104). In step 109, a follow-up page which is dynamically generated based on the previously received data and which includes a login acknowledgement as well as a script reference to a vehicle identification script is sent by the server according to the request. Then, in step 110, a request (URL address) for the vehicle identification script is expected to be received. The receipt of a request is followed by step 111. If no request is received, then the communication is unsuccessfully terminated. In step 111, the server sends the vehicle identification script according to the request. Then, in step 112, a request (URL address) for a continuation page including vehicle identification data is expected to be received. The receipt of a request including data is followed by step 113. If no request or data is received, then the communication is terminated. In step 113, the server generates a diagnostic script for the respective vehicle from its database according to the received vehicle data.

If a script for the received data is not generatable, then either a standard script is used or the process is terminated (step 124). Then, an error message in the form of a WML page, or a reference to such an error message, is returned (step 125). In subsequent step 114, the server sends a continuation page including a reference to the diagnostic script (URL address) according to the request. Then, in step 115, a request (URL address) for the script is expected to be received. The receipt of a request is followed by step 116. If no request or data is received, then the communication is unsuccessfully terminated. In step 116, the server sends the vehicle identification script according to the request. Then, in step 117, a request (URL address.) for a continuation page including diagnostic data is expected to be received. The receipt of a request including data (see step 126) is followed by step 118. If no data is received, then the communication is aborted/terminated. Then, an error message in the form of a WML page, or a reference to such an error message, is returned (step 127).

In step 118, the server determines the diagnostic result according to the received diagnostic data using its database. In subsequent step 119, the server sends the diagnostics result page according to the request. Then, in step 120, a request (URL address) for a recommendation page is expected to be received. The receipt of a request is followed by step 121.

If no request is received, then this communication is unsuccessfully terminated (step 104). In step 121, the server establishes recommendations for further action according to the received diagnostic data using its database. In subsequent step 122, the server sends the client the recommendation page according to the request (and terminates the communication and thus the remote diagnostics process in step 104).

To be able to establish a connection between the essentially independent and anonymous requests of the client on the server side, the client is assigned a unique session ID at the beginning of the communication (upon login) which is used by the client from that point on to identify itself for each request. This allows the server to identify the origin of each request. In Internet applications, this type of session management is well understood and widespread.

The program according to FIG. 5 is activated by a user. In step 200, the client sends a request (predefined URL address) to the server requesting the remote diagnosis to be started. In step 201, the receipt of an activation page is verified. If a page is received, for example, within a set time, then step 202 follows. If no page is received, then the communication is unsuccessfully aborted/terminated (step 204). In step 202, the client sends the server a request for a login page (URL address). Then, in step 205, the receipt of a corresponding page is verified. If a page is received, for example, within a set time, then step 206 follows.

If no page is received, then the communication is aborted/terminated (step 204). In step 206, the client sends a request for a login script. Then, in step 207, the receipt of the login script is verified. If the script is received, for example, within a set time, then step 208 follows. If no script is received, then the communication is aborted/terminated (step 204). In step 208, the user identification data is retrieved from a storage device (using the EFI interface) and sent to the server along with a request for a continuation page. Then, in step 210, the receipt of a continuation page including a login acknowledgement and a script reference is verified. If a continuation page including the appropriate information is received, for example, within a set time, then step 211 follows. If no page or acknowledgement is received, then the communication is aborted/terminated (step 204). In step 211, a request for a vehicle identification script is sent.

Then, in step 212, the receipt of a script is verified. If a script is received, for example, within a set time, then step 213 follows. If no script is received, then the communication is unsuccessfully aborted/terminated (step 204). In step 213, the vehicle identification data is acquired (for example, from a storage device in the terminal device, or by querying the control units/components to be diagnosed (using the EFI interface)), and a request for a continuation page is sent together with the identification data. Then, in step 214, the receipt of a diagnostics page including a reference to the script is verified. If a page is received, for example, within a set time, then step 215 follows. If no data is received, then the communication is unsuccessfully aborted/terminated (step 204). In step 215, a request is made for a diagnostic script.

Then, in step 216, the receipt of a diagnostic script is verified. If a script is received, for example, within a set time, then step 217 follows. If no WML script is received, then the communication is aborted/terminated (step 204). In step 217, the diagnostic data is determined by appropriate communication with the control units to be diagnosed (using the EFI interface) and sent along with a request for a continuation page. Then, in step 218, the receipt of a result page is verified. If a request including data is received, for example, within a set time, then step 219 follows. If no response page is received, then the communication is unsuccessfully aborted/terminated (step 204). Based on the result, it is determined in step 219 whether to request a recommendation page.

If not, the process is terminated (step 204); if yes, a corresponding request is sent (step 220). Then, in step 222, the receipt of a recommendation page is verified. If a page is received, for example, within a set time, then step 223 follows. If no page is received, then the communication is aborted/terminated (step 204). In step 223, the recommendation page is displayed, and the communication and thus the remote diagnostics process is terminated according to step 204.

In between times, the received pages are usually displayed as well (including the status info generated by the server).

1-14. (canceled)

15. A method for communicating information associated with a vehicle, the method comprising:
communicating the information, a client being provided on the vehicle side, a server being provided on a mobile radio network side, the communicating including transmitting information by communication between the server and the client via a mobile radio network,
wherein the information is used to implement vehicle-related remote monitoring or control, and the communication is done based on a standardized protocol that is adapted to conditions of the mobile radio network.

16. A method for communicating information associated with a vehicle, the method comprising:
at least one of sending and receiving the information, a client to communicate with a server via a mobile radio network being provided on the vehicle side,
wherein the information is used to implement vehicle-related remote monitoring or control;
sending requests to call up and receive information, including commands; and
acquiring data as a function of the information and sending it to the server.

17. A method for communicating information in conjunction with a vehicle, the method comprising:
at least one of sending and receiving the information, a server to communicate with an on-board client via a mobile radio network being provided on the network side,
wherein the information is used to implement vehicle-related remote monitoring or control;
selecting and sending the information based on a received request; and
receiving and processing data of the information to provide results, and returning the results.

18. The method of claim 16, wherein a sent request is based on a use of a URL address.

19. The method of claim 15, wherein the information includes WAP pages that are transmitted as WML pages, and which include references to at least one of scripts and dynamically generated data.

20. The method of claim 15, wherein the information includes scripts which are transmitted as WML scripts and which are used to perform certain actions in client, the client being an on-board client.

21. The method of claim 19, wherein the scripts include one of a vehicle-specific diagnostic protocol and a vehicle-specific information.

22. The method of claim 15, wherein the communication is with at least one independent external application that is implemented in the client, which is a mobile client, that occurs via a standardized functional interface between a mobile radio communication element and the external application.

23. A device for transmitting information in conjunction with a vehicle, comprising:
a communicating arrangement, including a client on the vehicle side and a server on a network side, which communicate with each other via a mobile radio network,
wherein the information is used to implement vehicle-related remote monitoring or control, the server and the client including an arrangement to communicate based on a standardized protocol that is adapted to conditions of the mobile radio network.

24. A device for at least one of sending and receiving information in conjunction with a vehicle, comprising:
a client on the vehicle side that communicates with a server via a mobile radio network, wherein the information is for implementing vehicle-related remote monitoring or control, and wherein the client includes modules to call up and receive the information, including commands, by sending a request, the client further including an acquisition arrangement to acquire data as a function of the information.

25. The device of claim 24, wherein in the client, at least one independent external application is implemented, and a standardized functional interface, which is an EFI interface, via which the communication with the application occurs, is present between a mobile radio communication element and the external application.

26. A device for at least one of sending and receiving information in conjunction with a vehicle, comprising:
a server on a network side to communicate with an on-board client via a mobile radio network, wherein the information is for implementing vehicle-related remote monitoring or control, the server includes a selecting arrangement to select and return the information based on a received request, and the server further includes a receiving arrangement to receive and process the data to provide results, and return the results.

27. A computer program executable by a processor, comprising:
computer program code for communicating information associated with a vehicle by performing the following:
communicating the information, a client being provided on the vehicle side, a server being provided on a mobile radio network side, the communicating including transmitting information by communication between the server and the client via a mobile radio network,
wherein the information is used to implement vehicle-related remote monitoring or control, and the communication is done based on a standardized protocol that is adapted to conditions of the mobile radio network.

28. A computer medium including a computer program executable by a processor, comprising:
computer program code for communicating information associated with a vehicle by performing the following:
communicating the information, a client being provided on the vehicle side, a server being provided on a mobile radio network side, the communicating including transmitting information by communication between the server and the client via a mobile radio network,
wherein the information is used to implement vehicle-related remote monitoring or control, and the communication is done based on a standardized protocol that is adapted to conditions of the mobile radio network.

29. The method of claim 1, wherein the standard protocol is a WAP protocol.

30. The device of claim 23, wherein the standard protocol is a WAP protocol.
